(19) United States
(12) Patent Application Publication
(10) Pub. No.: US 2014/0195421 A1
(43) Pub. Date: Jul. 10, 2014

(54) FACTORING IN FREIGHT TRANSPORTATION UTILIZING AUTHENTICATED DATA

(71) Applicant: TRAKKX.COM, LLC, Kingsburg, CA (US)

(72) Inventor: John LOZITO, Encinitas, CA (US)

(21) Appl. No.: 13/830,203

(22) Filed: Mar. 14, 2013

Related U.S. Application Data
(60) Provisional application No. 61/749,145, filed on Jan. 4, 2013.

(51) Int. Cl. G06Q 10/08; G06Q 20/14

(52) U.S. Cl. CPC G06Q 10/083; G06Q 20/14
USPC 705/40; 705/337; 705/333

(57) ABSTRACT

Freight transport factoring platforms, systems, and applications comprising: a database of at least one freight transport order, each order comprising an association of freight transport equipment information, operator information, and freight information; a software module configured to: (I) receive freight transport equipment information transmitted by the electronic device and (II) associate the freight transport equipment information with an order; and a software module configured to communicate an order and associated freight transport equipment information to a factoring application; provided that the communicated order and associated freight transport equipment information comprise information derived from the electronic device physically attached to the freight transport equipment, including methods of using the same.

### CROSS-REFERENCE TO RELATED APPLICATIONS

This application claims the benefit of U.S. Application Ser. No. 61/749,145, filed Jan. 4, 2013, which is hereby incorporated by reference in its entirety.

### BACKGROUND OF THE INVENTION

The Federal Bureau of Transportation Statistics reports that approximately 20 billion tons of freight are transported in the U.S. each year. Freight is transported via truck, rail, water, air, and other modes, with the majority being transported by truck. The trucking industry involves the transport and distribution of commercial and industrial goods using commercial motor vehicles; usually semi trucks, box trucks, or dump trucks. The trucking industry provides an essential service to the American economy by transporting large quantities of raw materials, works in process, and finished goods over land—typically from manufacturing plants to retail distribution centers.

### SUMMARY OF THE INVENTION

Factoring is a financial transaction whereby a business sells its accounts receivable (i.e., invoices) to a third party at a discount. Typically, there are three parties involved in this type of transaction: a party who sells the account receivable, the debtor, and a factoring company. The sale of the receivables essentially transfers ownership of the receivables to the factoring company. Accordingly, the factoring company obtains the right to receive the payments made by the debtor for the invoice amount and, in nonrecourse factoring, must bear the loss if the account debtor does not pay the invoice amount due solely to a financial inability to pay.

In some cases, factoring is used in the freight hauling industry by carriers, brokers, and operators to obtain cash or accelerate payment on freight hauling contracts. For example, in advance factoring, the factoring company provides financing to the seller of the account receivable in the form of a cash advance. In some cases, a cash advance is an upfront payment of 70-85% of the purchase price of the accounts, with the balance of the purchase price being paid, less the factoring company's discount fee and other charges, upon collection from the account client (e.g., a shipper, receiver, etc.). In other cases, a factoring company provides progress payments at predetermined milestones in completion of a freight hauling contract.

In some cases, debt factoring is used as a financial instrument to provide better cash flow control especially if a freight hauler is managing a plurality of accounts receivable with different credit terms. For example, in maturity factoring, a factoring company makes no advance on the purchased accounts; rather, the purchase price is paid on or about the average maturity date of the accounts being purchased in the batch.

Existing freight hauling financing and factoring systems fail to provide features to improve or ensure authenticity of relevant data such as the status of freight transport equipment, location of freight or freight transport equipment, and achievement of progress or milestones in a freight transport contract. Traditionally, freight hauling financing and factoring applications are slowed by the need for manual verification of data or are susceptible to fraud through falsified or manipulated data.

Advantages of the platforms, systems, media, and methods described herein include, but are not limited to, providing more frequent and timely advance payment options for freight haulers and reduction of risk for factoring companies by introducing data with improved data authenticity and/or integrity.

In one aspect, disclosed herein are computer-implemented systems comprising: an electronic device attached to freight transport equipment and configured to wirelessly transmit freight transport equipment information to a server; a server processor configured to provide a server application comprising: a database of at least one freight transport order, each order comprising an association of freight transport equipment information, operator information, and freight information; a software module configured to: (I) receive freight transport equipment information transmitted by the electronic device and (II) associate the freight transport equipment information with an order; and a software module configured to communicate an order and associated freight transport equipment information to a factoring application; provided that the communicated order and associated freight transport equipment information comprise information derived from the electronic device physically attached to the freight transport equipment. In some embodiments, the communicated order and associated freight transport equipment information comprise information derived directly and automatically from the electronic device attached to the freight transport equipment. In some embodiments, the electronic device physically connected to the freight transport equipment comprises a GPS chip and cellular modem. In some embodiments, the freight transport equipment is a: tractor, trailer, shipping container, rail car, aircraft, or watercraft. In some embodiments, the freight transport equipment information comprises one or more of: type of freight transport equipment, telemetry information, load status, and freight integrity information. In further embodiments, the telemetry information comprises one or more of: location, direction, speed, heading, and altitude. In some embodiments, the freight information comprises one or more of: description of the freight, suitable type of freight transport equipment, suitable transport environmental conditions, pick-up location, pick-up date and time, drop-off location, and drop-off date and time. In some embodiments, the server application further comprises a software module configured to define a geofence associated with at least one of: a freight pick-up location, a waypoint, and a freight drop-off location. In further embodiments, a geofence is utilized to automatically update the status of freight transport equipment. In some embodiments, the system further comprises a device attached to freight transport equipment and configured to transmit operator biometric information. In further embodiments, the server application further comprises a software module configured to receive operator biometric information transmitted by the electronic device and associate the operator biometric information with an order. In some embodiments, the server application further comprises a software module configured to assign a level of data authenticity to the transmitted freight transport equipment information. In further embodiments, the level of data authenticity is based on method of installation of the electronic device physically connected to the freight transport equipment. In further embodiments, the level of data authenticity is based on last inspection date for the electronic device physically connected to the freight transport equipment. In some embodiments, the factoring application is configured to make progress payments on freight transport contracts. In further embodiments, the progress payments are made at one or more of: freight pick-up, freight drop-off, a predetermined mileage, a predetermined waypoint, a predetermined distance from the destination, and a predetermined percent completion. In some embodiments, the orders and associated freight transport equipment information are communicated to the factoring application periodically, substantially continuously, or in real-time.

In another aspect, disclosed herein are non-transitory computer-readable storage media encoded with a computer program including instructions executable by a processor to create an application comprising: a database of freight transport orders, each order comprising an association of freight transport equipment information, operator information, and freight information; the freight transport equipment information at least partially derived from an electronic device physically attached to freight transport equipment; a software module configured to receive freight transport equipment information transmitted by the electronic device and associate the freight transport equipment information with an order; and a software module configured to communicate orders and associated freight transport equipment information to a factoring application. In some embodiments, the freight transport equipment information is at least partially derived directly and automatically from an electronic device physically attached to freight transport equipment. In some embodiments, the factoring application is configured to make progress payments on freight transport contracts. In further embodiments, the progress payments are made at one or more of: freight pick-up, freight drop-off, a predetermined mileage, a predetermined waypoint, a predetermined distance from the destination, and a predetermined percent completion. In some embodiments, the orders and associated freight transport equipment information are communicated to the factoring application periodically, substantially continuously, or in real-time.

In another aspect, disclosed herein are computer-implemented freight transport factoring methods comprising the steps of: maintaining, in a computer memory, a database of freight transport orders, each order comprising an association of freight transport equipment information, operator information, and freight information; receiving, by a computer, freight transport equipment information transmitted by an electronic device physically attached to the freight transport equipment; associating, by a computer, the freight transport equipment information transmitted by the electronic device with an order; and communicating, by a computer, orders and associated freight transport equipment information to a factoring application, the communicating performed periodically. In some embodiments, the factoring application is configured to make progress payments on freight transport contracts. In further embodiments, the progress payments are made at one or more of: freight pick-up, freight drop-off, a predetermined mileage, a predetermined waypoint, a predetermined distance from the destination, and a predetermined percent completion. In some embodiments, the orders and associated freight transport equipment information are communicated to the factoring application periodically, substantially continuously, or in real-time.

In another aspect, disclosed herein are freight transport factoring platforms comprising: a first processor configured to provide a freight tracking application comprising: a database of freight transport orders, each order comprising an association of freight transport equipment information, operator information, and freight information; the freight transport equipment information at least partially derived from an electronic device physically attached to freight transport equipment; a software module configured to receive freight transport equipment information transmitted by the electronic device and associate the freight transport equipment information with an order; and a software module configured to communicate orders and associated freight transport equipment information to a factoring application; and a second processor configured to provide a factoring application comprising: a software module configured to receive orders and associated freight transport equipment information from a freight tracking application; a software module configured to make electronic progress payments on freight transport contracts. In some embodiments, the freight transport equipment information is at least partially derived directly and automatically from an electronic device physically attached to freight transport equipment. In some embodiments, the progress payments are made at one or more of: freight pick-up, freight drop-off, a predetermined mileage, a predetermined waypoint, a predetermined distance from the destination, and a predetermined percent completion. In some embodiments, the orders and associated freight transport equipment information are communicated to the factoring application periodically, substantially continuously, or in real-time.

### BRIEF DESCRIPTION OF THE DRAWINGS

FIG. 1 shows a non-limiting example of an electronic device for generating and wirelessly transmitting freight transport equipment information; in this case, a device including a hardened protective case with attachment points to facilitate securing the device to freight transport equipment.

FIG. 2 shows a non-limiting exemplary schematic diagram of an electronic device for generating and wirelessly transmitting freight transport equipment information; in this case, a device including a processor, power sources, a GPS module, a GSM module, an accelerometer module, and input/output for a plurality of sensors.

FIG. 3 shows a non-limiting example of a graphic user interface (GUI); in this case, a display including a plurality of orders. For each order, the display includes a party to be billed, a pick-up date, a driver, a carrier, an origination city, an origination state, a destination city, a destination state, a description of the freight, weight of the freight, purchase order numbers, a delivery date, a current location, and a load status.

### DETAILED DESCRIPTION OF THE INVENTION

Current freight hauling financing and factoring technologies fail to adequately incorporate high authenticity/integrity data to reduce the need for manual verification and prevent falsification/manipulation of information. As a result, existing freight hauling financing and factoring systems fail to provide more frequent and timely advance payment options for freight haulers and fail to adequately reduce risks for factoring companies.

Described herein, in certain embodiments, are computer-implemented systems comprising: an electronic device attached to freight transport equipment and configured to wirelessly transmit freight transport equipment information to a server; a server processor configured to provide a server application comprising: a database of at least one freight transport order, each order comprising an association of freight transport equipment information, operator information, and freight information; a software module configured to: (I) receive freight transport equipment information transmitted by the electronic device and (II) associate the freight transport equipment information with an order; and a software module configured to communicate an order and associated freight transport equipment information to a factoring application; provided that the communicated order and associated freight transport equipment information comprise information derived from the electronic device physically attached to the freight transport equipment.

Also described herein, in certain embodiments, are non-transitory computer-readable storage media encoded with a computer program including instructions executable by a processor to create an application comprising: a database of freight transport orders, each order comprising an association of freight transport equipment information, operator information, and freight information; the freight transport equipment information at least partially derived from an electronic device physically attached to freight transport equipment; a software module configured to receive freight transport equipment information transmitted by the electronic device and associate the freight transport equipment information with an order; and a software module configured to communicate orders and associated freight transport equipment information to a factoring application.

Also described herein, in certain embodiments, are computer-implemented freight transport factoring methods comprising the steps of: maintaining, in a computer memory, a database of freight transport orders, each order comprising an association of freight transport equipment information, operator information, and freight information; receiving, by a computer, freight transport equipment information transmitted by an electronic device physically attached to the freight transport equipment; associating, by a computer, the freight transport equipment information transmitted by the electronic device with an order; and communicating, by a computer, orders and associated freight transport equipment information to a factoring application, the communicating performed periodically.

Also described herein, in certain embodiments, are freight transport factoring platforms comprising: a first processor configured to provide a freight tracking application comprising: a database of freight transport orders, each order comprising an association of freight transport equipment information, operator information, and freight information; the freight transport equipment information at least partially derived from an electronic device physically attached to freight transport equipment; a software module configured to receive freight transport equipment information transmitted by the electronic device and associate the freight transport equipment information with an order; and a software module configured to communicate orders and associated freight transport equipment information to a factoring application; and a second processor configured to provide a factoring application comprising: a software module configured to receive orders and associated freight transport equipment information from a freight tracking application; a software module configured to make electronic progress payments on freight transport contracts.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Freight Transport Equipment

In some embodiments, the platforms, systems, media, and methods described herein include freight transport equipment, or use of the same. In some embodiments, the systems, devices, software, and methods described herein include a device attached to freight transport equipment, or use of the same. In further embodiments, a device attached to freight transport equipment is configured to transmit freight transport equipment information.

Many types of freight transport equipment are suitable. in various embodiments, suitable freight transport equipment includes, by way of non-limiting examples, automobiles, tractors, trailers, shipping containers, rail cars, aircraft, watercraft, and the like. In some embodiments, suitable freight transport equipment includes automobiles such as cars, trucks, tow trucks, vans, busses, etc. In some embodiments, suitable freight transport equipment includes tractors such as semi-tractors, semi-trailer trucks, transfer trucks, articulated vehicles, dump trucks, logging trucks, tank trucks, refrigerated trucks, road trains, auto transport trucks, etc. In some embodiments, suitable freight transport equipment includes trailers such as semi-trailers, box trailers, dry bulk trailers, refrigerated trailers, bus trailers, tank trailers, dump trailers, auto transport trailers, flatbed trailers, single trailers, multiple (e.g., double, triple, stacked, etc.), and the like. In some embodiments, suitable freight transport equipment includes shipping containers such as intermodal freight containers, boxes (including wooden boxes), corrugated boxes (including fiberboard boxes), crates, intermediate bulk shipping containers, intermediate bulk containers, flexible intermediate bulk containers, bulk boxes, drums (including steel drums), insulated shipping containers, etc. In some embodiments, suitable freight transport equipment includes rail cars such as auto racks, box cars, center beam cars, flat cars, well cars, gondolas, hoppers, lorries, open wagons, refrigerator cars, side dump cars, spine cars, stock cards, tank cars, Schnabel cars, etc. In some embodiments, suitable freight transport equipment includes aircraft such as propeller aircraft, jet aircraft, rotorcraft, gliders, blimps, balloons, etc. In some embodiments, suitable freight transport equipment includes watercraft such as airboat, barge, sailboat, cabin cruiser, cargo ship, catamaran, cruise ship, fishing boat, hovercraft, hydrofoil, hydroplane, ice boat, jet boat, pontoon boat, ferry, submarine, tanker, tug boat, etc. In some embodiments, manned and/or unmanned freight transport equipment is suitable.

### Device

In some embodiments, the platforms, systems, media, and methods described herein include an electronic device physically connected to (or integrated with) freight transport equipment, or use of the same. In some embodiments, the electronic device generates freight transport equipment information and transmits it to the platforms, systems, and media described herein.

Many mechanisms of attachment are suitable. In various embodiments, a device is attached to freight transport equipment by, for example, fasteners, adhesives, welds, and the like. In some embodiments, a mechanism of attachment prevents tampering of the device or removal of the device from the freight transport equipment. In further embodiments, a device has a rugged, reinforced, or armored case and is attached to freight transport equipment via a permanent, substantially permanent, or semi-permanent mechanism.

In some embodiments, a device attached to freight transport equipment is configured to transmit freight transport equipment information described further herein. In some embodiments, a device attached to freight transport equipment and configured to transmit freight transport equipment information is a digital processing device comprising a processor. In some embodiments, a device attached to freight transport equipment and configured to transmit freight transport equipment information includes a power source. In various embodiments, a suitable power source is a power line in from the freight transport equipment, a battery (e.g., zinc-carbon (ZnC), alkaline, nickel-cadmium (NiCd), nickel-zinc (NiZn), nickel metal hydride (NiMH), lithium-ion (Li-ion), etc.), or both. In some embodiments, a device attached to freight transport equipment and configured to transmit freight transport equipment information includes a sensor input/output (I/O) element. In some embodiments, a device attached to freight transport equipment includes a location component. In further embodiments a device includes a GPS element to access a positioning system. In some embodiments, a device attached to freight transport equipment includes a communications component. In further embodiments a device includes a telecommunications element (e.g., GSM or similar) to communicate with a cellular phone network.

In some embodiments, a device attached to freight transport equipment transmits freight transport equipment information on a continuous or substantially continuous basis. In other embodiments, a device attached to freight transport equipment transmits information on a periodic basis. Many transmission periods are suitable. In further embodiments, a device attached to freight transport equipment stores information and transmits the information if and when a suitable communication channel becomes available. For example, a device utilizing a cellular radio to transmit information and attached to an aircraft or to freight in an aircraft may not be able to transmit information during portions of the transport. In such cases, a device optionally stores freight transport equipment information, freight integrity information, and/or operator biometric information in a memory device and transmits the information if and when a cellular network signal becomes available.

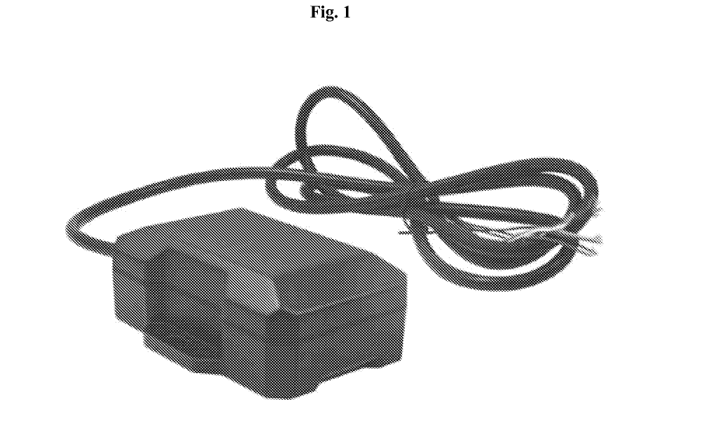

Referring to FIG. 1, in a particular embodiment, a device is suitable for attachment to freight transport equipment and is configured to transmit freight transport equipment information. In this embodiment, the device includes a hard plastic case with features to facilitate attachment.

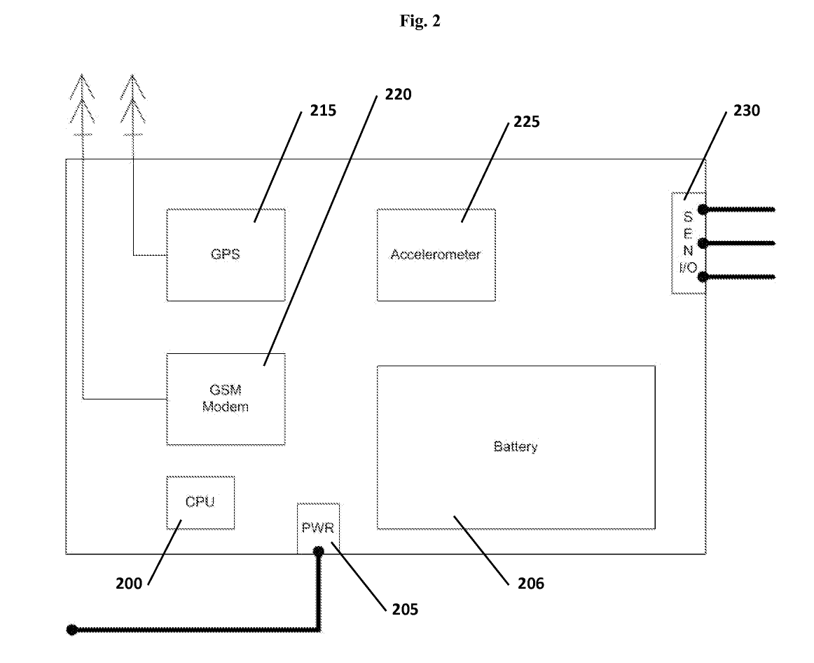

Referring to FIG. 2, in a particular embodiment, a device is suitable for attachment to freight transport equipment and is configured to transmit freight transport equipment information. In this embodiment, the device includes a central processing unit (CPU) 200 and both a line in 205 and a battery 206 to provide power. Further in this embodiment, the device includes a GPS module 215 with an antenna to access a positioning system and a GSM module 220, also with an antenna to communicate with a cellular phone network. The device in this embodiment further includes sensor elements such as an accelerometer module 225 and in input/output element 230 for a network of sensors.

A device is optionally attached to freight transport equipment by a number of suitable parties. In some embodiments, a device is attached to freight transport equipment by a shipper, a carrier, a broker, an operator, a receiver, an equipment owner, or a factoring company. In other embodiments, a device is attached to freight transport equipment by a third party provider of the systems, devices, software, and methods described herein. In some embodiments, the quality and/or reliability of freight transport equipment information transmitted by a device is determined, at least in part, by the party attaching the device to freight transport equipment.

A device (attached to freight transport equipment) is optionally inspected at one or more time points by a number of suitable parties. In various embodiments, a device is suitably inspected for, by way of non-limiting examples, integrity, attachment, tampering, and the like. In some embodiments, a device is inspected by a shipper, a carrier, a broker, an operator, a receiver, an equipment owner, or a factoring company. In other embodiments, a device is inspected by a third party provider of the systems, devices, software, and methods described herein. A device is suitably inspected at a variety of time points and/or time intervals. In some embodiments, a device is inspected at one or more key points in freight transport, including, by way of non-limiting examples, pickup, a way point, drop off, and the like. In some embodiments, a device is inspected periodically. In various further embodiments, a device is inspected yearly, semi-yearly, quarterly, month, semi-monthly, weekly, daily, and hourly, including increments therein. In some embodiments, the quality and/or reliability of freight transport equipment information transmitted by a device is determined, at least in part, by the party inspecting the device, the time point(s) of inspection, and/or the time interval between inspections.

### Freight Transport Equipment Information

In some embodiments, the platforms, systems, media, and methods described herein include freight transport equipment information, or use of the same. In some embodiments, freight transport equipment information is paired with freight information to create an order. In further embodiments, orders and associated freight transport equipment information are communicated (e.g., transmitted) to a factoring application. In further embodiments, the communicated order and associated freight transport equipment information comprise information derived from an electronic device physically attached to the freight transport equipment. In still further embodiments, the communicated order and associated freight transport equipment information comprise information derived directly and automatically from an electronic device attached to the freight transport equipment.

Many types of freight transport equipment information are suitable. In various embodiments, suitable freight transport equipment information includes, by way of non-limiting examples, freight transport equipment type (e.g., reefer, flatbed, tanker, auto transport, van, etc.), freight transport equipment operator (e.g., driver), freight transport equipment carrier (e.g., operating authority the equipment is operated under), freight transport equipment location information, freight transport equipment status information, freight integrity information, and the like.

In some embodiments, suitable freight transport equipment information includes location information. In further embodiments, location information includes telemetry information. In still further embodiments, telemetry information includes, by way of non-limiting examples, location (e.g., latitude/longitude, street address, intersection, distance to a landmark, position on a map, etc.), speed, direction (e.g., heading, etc.), and altitude. In still further embodiments, telemetry information is graphed and/or charted over time to illustrate, for example, location, speed, and/or altitude over the course of transport.

In some embodiments, suitable freight transport equipment information includes equipment status information, optionally including load status. In further embodiments, freight transport equipment status information indicates whether freight is loaded or not. In further embodiments, freight transport equipment status information indicates whether freight transport equipment has departed or reached a particular location (e.g., a pickup, a drop off, a waypoint, etc.). In further embodiments, freight transport equipment status information indicates whether freight transport equipment is busy or available. In still further embodiments, freight transport equipment status information includes, by way of non-limiting examples, available, booked, dispatched, arrived at pick up, loaded, arrived at drop off, dropped, and empty.

In some embodiments, suitable freight transport equipment information includes freight integrity information. In further embodiments, freight integrity information indicates the conditions that freight is exposed to during transport. In still further embodiments, freight integrity information indicates whether freight is exposed to conditions beyond certain thresholds during transport. In still further embodiments, freight integrity information indicates whether freight is accessed, stolen, tampered with, or adulterated during transport. In some embodiments, freight integrity information includes, by way of non-limiting examples, temperature, humidity, atmospheric pressure, vibration, shock, and ambient light. In some embodiments, freight integrity information includes, door status (e.g., unopened, opened, opened a particular number of times, opened for a particular time period, etc.). In further embodiments, freight integrity information is graphed and/or charted over time to illustrate, for example, temperature, humidity, atmospheric pressure, shock and/or vibration over the course of transport.

In some embodiments, freight integrity information is verified through the recording and uploading of audio and/or still or video imagery. For example, in further embodiments, one or more still or video cameras capture photographic documentation of the integrity of the freight and one or more time points (including at regular periodic intervals). Suitable photographic documentation includes, by way of non-limiting examples, images of freight captured by one or more cameras located in the freight transport compartment of the freight transport equipment, images of the freight transport equipment captured by one or more cameras located on the exterior of the equipment, and images of the area surrounding the freight transport equipment captured by one or more cameras located on the exterior of the equipment.

In view of the disclosure provided herein, those of skill in the art will recognize that many databases are suitable for storage and retrieval of freight transport equipment information, including any of the databases described herein.

### Freight Information

In some embodiments, the platforms, systems, media, and methods described herein include freight information, or use of the same. In some embodiments, freight information is paired with freight transport equipment information to create an order. In further embodiments, orders and associated freight information are communicated (e.g., transmitted) to a factoring application. In further embodiments, the communicated order and associated freight information comprise information derived from an electronic device physically attached to the freight transport equipment. In still further embodiments, the communicated order and associated freight information comprise information derived directly and automatically from an electronic device attached to the freight transport equipment.

Many types of freight information are suitable. In various embodiments, suitable freight information includes, by way of non-limiting examples, description of the freight, pick-up location, pick-up date, pick-up time, drop-off location, drop-off date, drop-off time, suitable type(s) of freight transport equipment (e.g., tanker, flatbed, auto transport, etc.), suitable transport environmental conditions (e.g., temperature, humidity, atmospheric pressure, vibration, etc.), and the like.

In view of the disclosure provided herein, those of skill in the art will recognize that many databases are suitable for storage and retrieval of freight transport equipment information, including any of the databases described herein.

### Orders

In some embodiments, the platforms, systems, applications, and methods described herein include one or more load board orders, or use of the same. In further embodiments, an order comprises an association of freight transport equipment information, operator information, and freight information. In still further embodiments, an order comprises rate information, accounts payable, and/or accounts receivable information for use by a finance company or a factoring company.

In some embodiments, an order is formed when a party posting availability of freight forms an association with a posting indicated availability of freight transport equipment. In other embodiments, an order is formed when a party posting availability of freight transport equipment forms an association with a posting indicated availability of freight.

### User Console Display

In some embodiments, the platforms, systems, media, and methods described herein include a software module configured to provide a user console display, or use of the same. In some embodiments, a user console displays freight transport orders. In further embodiments, a freight transport order comprises freight information associated with freight transport equipment information an association of freight transport equipment information, operator information, and freight information. In some embodiments, an order comprises rate information, accounts payable, and/or accounts receivable information for use by a finance company or a factoring company. In some embodiments, a user console displays a data authenticity score, rank, or rating in association with an order. In some embodiments, a user console displays rate information, accounts payable, and/or accounts receivable information in association with an order.

In some embodiments, a user console display is intranet-based. In some embodiments, a user console display is internet-based. In further embodiments, a user console display is web-based. In still further embodiments, a user console display is cloud computing based. In some embodiments, a user console display is implemented as a web application and offered as software-as-a-service. In other embodiments, a user console display is implemented as a mobile application offered for purchase and download. In yet other embodiments, a user console display is implemented as a free mobile application available for download.

The information displayed by a user console described herein is updated at a wide range of suitable time intervals. In various embodiments, the information displayed by a user console described herein is updated, for example, at least every 12, 11, 10, 9, 8, 7, 6, 5, 4, 3, 2, 1, or less hours, including increments therein. In various further embodiments, the information displayed by a user console described herein is updated, for example, at least every 60, 55, 50, 45, 40, 35, 30, 25, 20, 15, 14, 13, 12, 11, 10, 9, 8, 7, 6, 5, 4, 3, 2, 1 or less minutes, including increments therein. In various further embodiments, the information displayed by a user console described herein is updated, for example, at least every 60, 55, 50, 45, 40, 35, 30, 25, 20, 15, 14, 13, 12, 11, 10, 9, 8, 7, 6, 5, 4, 3, 2, 1 or less seconds, including increments therein. In some embodiments, the information is updated continuously or substantially continuously such that the information is provided in real-time or substantially in real-time.

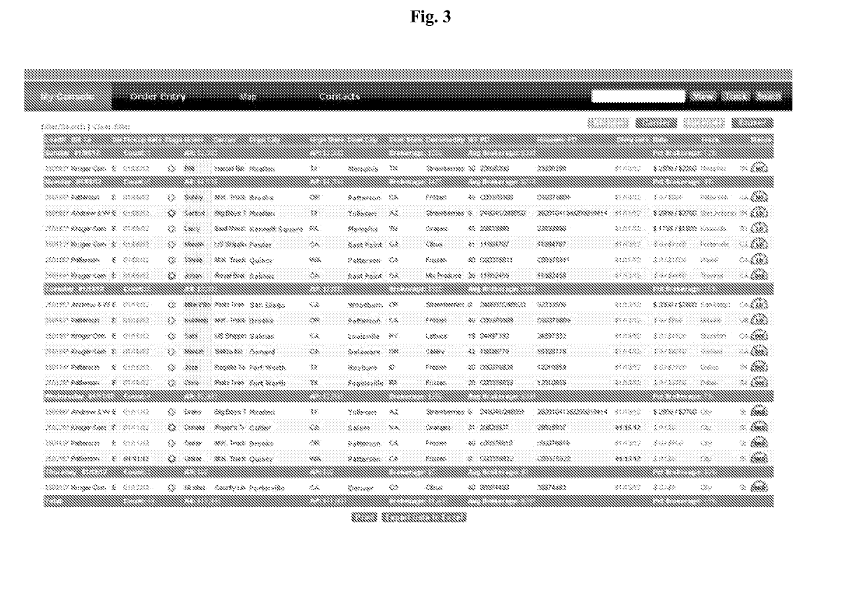

Referring to FIG. 3, in a particular embodiment, a user console display provides information on a plurality of orders. In this embodiment, for each order the display includes a billing rate, a party to be billed, a pick-up date, a driver, a carrier, an origination city, an origination state, a destination city, a destination state, a description of the freight, weight of the freight, purchase order numbers, a delivery date, a current location, and a load status.

### Geofencing

In some embodiments, the platforms, systems, media, and methods described herein include a software module for defining a geofence, or use of the same. As used herein, in some embodiments, a geofence is a virtual perimeter for a real-world geographic area. Many types of geofences are suitable for configuration with the systems, devices, software, and methods described herein. In various embodiments, geofences suitably define, for example, a pick-up location, a way point location, a device inspection location, a drop-off location, or the like.

A geofence suitably has any shape. In various embodiments, suitable geofence shapes include, by way of non-limiting examples, a circle (defined by a radius about a point), a square, a rectangle, a triangle, a polyhedron, an irregular shape, and the like. A geofence suitably has any size. In various embodiments, suitable geofence sizes include, by way of non-limiting examples, 50, 45, 40, 35, 30, 25, 20, 15, 10, 9, 8, 7, 6, 5, 4, 3, 2, 1 or less square kilometers, including increments therein. In various further embodiments, suitable geofence sizes include, by way of non-limiting examples, 1000, 900, 800, 700, 600, 500, 400, 300, 200, 100, 50, 45, 40, 35, 30, 25, 20, 15, 10 or less square meters, including increments therein.

In some embodiments, a geofence is used to update the status of, for example, an order, freight transport equipment, an operator, or the like, in a user console display. In a particular embodiment, one or more geofences are utilized to automatically update the status of freight transport equipment in a user console display. See, e.g., FIG. 3. In another particular embodiment, one or more geofences are utilized to automatically update the status of a freight transport order, freight transport equipment information, or freight information that is communicated/transmitted to a factoring application. For example, a carrier may configure a geofence of 10 square kilometers around the drop off location for a particular order. By way of further example, the status of the transport equipment is changed to “arrived at drop off” when the equipment enters the geofenced area. Many location based equipment statuses are suitable based on a geofence including, by way of non-limiting examples, available, booked, dispatched, arrived at pick up, loaded, arrived at drop off, drop, and empty.

In some embodiments, a geofence is used to trigger an alert or notification based on the location of freight transport equipment, the status of freight transport equipment, or the status of an order. In some embodiments, an alert or notification is provided via a use console display described herein. In some embodiments, an alert or notification is provided to a finance/factoring company. In certain embodiments, an alert or notification is provided via email, SMS, MMS, automated phone call, microblog entry, post to a social media application, site, or serves, and the like. Any of the stake holders described herein are suitable recipients for alerts and/or notifications. In some embodiments, alerts and notifications enhance the visibility, transparency, authenticity, and integrity of order status, freight transport equipment information, operator information, and the like.

### Operator Information

In some embodiments, the platforms, systems, media, and methods described herein include freight transport equipment operator information, or use of the same. In further embodiments, operator information identifies an operator associated with a freight transport order. In still further embodiments, operator information identifies an operator operating freight transport equipment specified in an order. In still further embodiments, operator information identifies an operator participating in transport of freight specified in an order.

Many types of operator information are suitable. In some embodiments, suitable operator information identifies an operator. In some embodiments, suitable operator information indicates an operator's professional record, professional performance, licensures, and the like. In various embodiments, suitable operator information includes, by way of non-limiting examples, name, age, date of birth, address, phone number, social security number, state issuing driver's license, driver's license number, operating history, biometric information, and the like.

Many types of operating histories are suitable. In various embodiments, operating histories includes, by way of non-limiting examples, driving records, professional performance reviews, professional discipline records, criminal records, insurance records, and the like.

Many types of biometric information are suitable. In various embodiments, suitable biometric information includes, by way of non-limiting examples, photographic information, retinal information, iris information, fingerprint information, palm print information, facial geometry information, voice information, and combinations thereof. In further various embodiments, photographic information includes one or more still or motion images of, for example, an operator's face, head and shoulders, or full body.

In view of the disclosure provided herein, those of skill in the art will recognize that many databases are suitable for storage and retrieval of operator information, including any of the databases described herein.

In some embodiments, the systems, devices, software, and methods described herein include a device attached to freight transport equipment, or use of the same. In further embodiments, a device attached to freight transport equipment is configured to transmit operator biometric information described herein. In some embodiments, a device attached to freight transport equipment and configured to transmit operator biometric information is attached to freight transport equipment in a location that is accessible by an operator. In further embodiments, such a device is accessible by an operator while operating the equipment. In some embodiments, a device attached to freight transport equipment and configured to transmit operator biometric information includes an input component to read or capture operator biometric information. In further embodiments, an input component includes, by way of non-limiting examples, a still camera, a video camera, a fingerprint reader, a palm print reader, a retina scanner, an iris scanner, and the like.

In some embodiments, an input component includes a camera to capture photographic information, facial geometry information, or combinations thereof. In further embodiments, a camera is a digital camera. In some embodiments, the digital camera is an autofocus camera. In some embodiments, a digital camera is a charge-coupled device (CCD) camera. In further embodiments, a digital camera is a CCD video camera. In other embodiments, a digital camera is a complementary metal-oxide-semiconductor (CMOS) camera. In some embodiments, a digital camera captures still images. In other embodiments, a digital camera captures video images. In various embodiments, suitable digital cameras include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, and higher megapixel cameras, including increments therein. In some embodiments, a digital camera is a standard definition camera. In other embodiments, a digital camera is an HD video camera. In further embodiments, an HD video camera captures images with at least about 1280×about 720 pixels or at least about 1920×about 1080 pixels. In some embodiments, a digital camera captures color digital images. In other embodiments, a digital camera captures grayscale digital images. In various embodiments, digital images are stored in any suitable digital image format. Suitable digital image formats include, by way of non-limiting examples, Joint Photographic Experts Group (JPEG), JPEG 2000, Exchangeable image file format (Exif), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), and WebP. In various embodiments, digital images are stored in any suitable digital video format. Suitable digital video formats include, by way of non-limiting examples, AVI, MPEG, Apple® QuickTime®, MP4, AVCHD®, Windows Media®, DivX™, Flash Video, Ogg Theora, WebM, and RealMedia. In further embodiments, a camera is a high-definition camera. In some embodiments, an input component includes a microphone to capture voice information.

### Factoring Application

In some embodiments, the platforms, systems, media, and methods described herein include a factoring application, or use of the same. In other embodiments, the platforms, systems, media, and methods described herein include a software module configured to communicate with a factoring application, or use of the same. As described herein, factoring is a financial transaction whereby a business sells its accounts receivable (i.e., invoices) to a factoring entity (at a discount), which obtains the right to receive the payments made by the debtor for the invoice amount. In the freight hauling industry, a carrier, broker, operator, or other party optionally sells an account receivable for a freight transport contract to a factoring company. In some cases, the factoring company makes a partial or complete advance payment to the seller and subsequently receives the payments made by a shipper, receiver, or other party for the invoice amount.

In some embodiments, a factoring application described herein receives and stores the terms and parameters of freight transport contracts. In still further embodiments, relevant terms and parameters of a freight transport contract include, by way of non-limiting examples, carrier, shipper, receiver, operator, rate information, accounts payable information, accounts receivable information, and the like. In some embodiments, the relevant terms and parameters of a freight transport contract include a data authenticity score, rank, or rating associated with a party to the contract. In a particular embodiment, a data authenticity score, rank, or rating is used by a factoring application to calculate or determine a discount rate, timing of an advance payment, or other payment terms.

In some embodiments, a factoring application described herein receives, stores, and tracks freight transport orders. In further embodiments, a factoring application described herein receives, stores, and tracks freight information and freight transport equipment information associated with freight transport orders. In still further embodiments, relevant freight information includes, by way of non-limiting examples, description of the freight, pick-up location, pick-up date, pick-up time, drop-off location, drop-off date, drop-off time, suitable type(s) of freight transport equipment (e.g., tanker, flatbed, auto transport, etc.), suitable transport environmental conditions (e.g., temperature, humidity, atmospheric pressure, vibration, etc.), and the like. In still further embodiments, relevant freight transport equipment information includes, by way of non-limiting examples, freight transport equipment type (e.g., reefer, flatbed, tanker, auto transport, van, etc.), freight transport equipment operator (e.g., driver), freight transport equipment carrier (e.g., operating authority the equipment is operated under), freight transport equipment location information, freight transport equipment status information, freight integrity information, and the like.

In preferred embodiments, the order information, associated freight transport equipment information, associated freight information, associated operator information comprise information derived from the electronic device physically attached to the freight transport equipment. In particular embodiments, the information derived directly and automatically from the electronic device physically attached to the freight transport equipment to enhance data authenticity, security, and integrity.

In some embodiments, a factoring application described herein executes payments based on a freight transport contract. Many methods of payment are suitable including, by way of non-limiting examples, issuance of a check, issuance of a debit card or gift card, electronic distribution to a debit card, electronic fund transfer, and the like. In further embodiments, progress payments are made by a factoring application based on the status of freight, freight transport equipment, and/or progress in completion of the freight hauling job. In still further embodiments, progress payments are made based on verification of freight pick-up, freight drop-off, a predetermined mileage, a predetermined waypoint, a predetermined distance from the destination, or a predetermined percent completion. In some embodiments, verification of freight pick-up may involve the inspection of one or more audio files, still photographs, and/or videos, collected by the freight integrity components disclosed herein and transmitted to the web portal.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of freight information, freight transport equipment information, freight transport order information, and progress payment information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following specific examples are to be construed as merely illustrative, and not limitative of the remainder of the disclosure in any way whatsoever. Without further elaboration, it is believed that one skilled in the art can, based on the description herein, utilize the present invention to its fullest extent.

### Example 1

### Creating an Order

A trucker accepts a job to transport and distribute potato chips at the three main hubs of a particular distribution region. The trucker wishes to sell his transportation invoice to a freight hauling factoring company, in order to help finance fuel and other expenses incurred in performing the job. The trucker submits information about himself as a truck operator (licensing, driving history, etc.), his freight transport equipment (e.g., tractor, trailer, etc.), the shipment, and terms of the contract to a factoring application server.

The server uses software to pair this information with an order. The software associates the order with additional operator, freight, accounts receivable and accounts payable, and information from past jobs, and communicates that order to a factoring application. The freight hauling factoring company accesses this information through the factoring application and determines that this trucker has an adequate transportation history and the shipper is creditworthy. The factoring company decides this is an acceptably credit-worthy invoice, and offers to buy the invoice from the trucker.

### Example 2

### Geofenced-Linked Progress Payments

The factoring company offers to buy the trucker's potato chip transport invoice, and the trucker accepts. The factoring company then notifies the potato chip company that they are handling the potato chip transport invoice, and that the potato chip company will pay the factoring company 20% of the transport contract when the trucker picks up the potato chip job, 20% for the first two deliveries the trucker makes in the three main hubs of the distribution region, and 40% for the third delivery and completion of the transportation contract.

The factoring company uses factoring software to define a geofence for each of these of these locations. The trucker first confirms his identity at the pick-up location through a fingerprint reader and camera combination associated with the electronic device in the trucker's semi-truck. Using information transmitted directly from an electronic device attached to the trucker's semi-truck, the factoring application confirms that the driver and freight transport equipment are within the previously defined geofenced area, and further accesses information about the integrity of the freight, including photographic documentation, trailer temperature, atmospheric pressure, vibration, door status, and location via GPS and cellular modem. Upon verification of the driver, location, and freight integrity, the factoring application completes an electronic funds transfer for 20% of the transport contract.

During the subsequent distribution of potato chips at the three previously determined drop-off locations, the electronic device attached to the trucker's equipment alerts the factoring application when the shipment enters the geofenced area. During the drop-offs, the trucker reconfirms his identity by way of fingerprint and photograph, the factoring application confirms the identity of the driver, the location and integrity of the shipment, and completes additional electronic funds transfers as previously agreed.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented system comprising:
a. an electronic device attached to freight transport equipment and configured to wirelessly transmit freight transport equipment information to a server;
b. a server processor configured to provide a server application comprising:
i. a database of at least one freight transport order, each order comprising an association of freight transport equipment information, operator information, and freight information;
ii. a software module configured to: (I) receive freight transport equipment information transmitted by the electronic device and (II) associate the freight transport equipment information with an order; and
iii. a software module configured to communicate an order and associated freight transport equipment information to a factoring application;
provided that the communicated order and associated freight transport equipment information comprise information derived from the electronic device physically attached to the freight transport equipment.

2. The system of claim 1, wherein the communicated order and associated freight transport equipment information comprise information derived directly and automatically from the electronic device attached to the freight transport equipment.

3. (canceled)

4. The system of claim 1, wherein the freight transport equipment is a: tractor, trailer, shipping container, rail car, aircraft, or watercraft.

5. The system of claim 1, wherein the freight transport equipment information comprises one or more of: type of freight transport equipment, telemetry information, load status, and freight integrity information.

6. (canceled)

7. (canceled)

8. The system of claim 1, wherein the server application further comprises a software module configured to define a geofence associated with at least one of: a freight pick-up location, a waypoint, and a freight drop-off location.

9. The system of claim 8, wherein a geofence is utilized to automatically update the status of freight transport equipment.

10. The system of claim 1, further comprising a device attached to freight transport equipment and configured to transmit operator biometric information.

11. The system of claim 10, wherein the server application further comprises a software module configured to receive operator biometric information transmitted by the electronic device and to associate the operator biometric information with an order.

12. (canceled)

13. (canceled)

14. (canceled)

15. The system of claim 1, wherein the factoring application is configured to make progress payments on freight transport contracts.

16. The system of claim 15, wherein the progress payments are made at one or more of: freight pick-up, freight drop-off, a predetermined mileage, a predetermined waypoint, a predetermined distance from the destination, and a predetermined percent completion.

17. (canceled)

18. Non-transitory computer-readable storage media encoded with a computer program including instructions executable by a processor to create an application comprising:
a. a database of freight transport orders, each order comprising an association of freight transport equipment information, operator information, and freight information; the freight transport equipment information at least partially derived from an electronic device physically attached to freight transport equipment;
b. a software module configured to receive freight transport equipment information transmitted by the electronic device and associate the freight transport equipment information with an order; and
c. a software module configured to communicate orders and associated freight transport equipment information to a factoring application.

19. The media of claim 18, wherein the freight transport equipment information is at least partially derived directly and automatically from an electronic device physically attached to freight transport equipment.

20. The media of claim 18, wherein the factoring application is configured to make progress payments on freight transport contracts.

21. The media of claim 20, wherein the progress payments are made at one or more of: freight pick-up, freight drop-off, a predetermined mileage, a predetermined waypoint, a predetermined distance from the destination, and a predetermined percent completion.

22. (canceled)

23. A computer-implemented freight transport factoring method comprising the steps of:
a. maintaining, in a computer memory, a database of freight transport orders, each order comprising an association of freight transport equipment information, operator information, and freight information;
b. receiving, by a computer, freight transport equipment information transmitted by an electronic device physically attached to the freight transport equipment;
c. associating, by a computer, the freight transport equipment information transmitted by the electronic device with an order; and
d. communicating, by a computer, orders and associated freight transport equipment information to a factoring application, the communicating performed periodically.

24. The method of claim 23, wherein the factoring application is configured to make progress payments on freight transport contracts.

25. The method of claim 24, wherein the progress payments are made at one or more of: freight pick-up, freight drop-off, a predetermined mileage, a predetermined waypoint, a predetermined distance from the destination, and a predetermined percent completion.

26. (canceled)

27. A freight transport factoring platform comprising:
a. a first processor configured to provide a freight tracking application comprising:
i. a database of freight transport orders, each order comprising an association of freight transport equipment information, operator information, and freight information; the freight transport equipment information at least partially derived from an electronic device physically attached to freight transport equipment;
ii. a software module configured to receive freight transport equipment information transmitted by the electronic device and to associate the freight transport equipment information with an order; and
iii. a software module configured to communicate orders and associated freight transport equipment information to a factoring application;
b. a second processor configured to provide a factoring application comprising:
i. a software module configured to receive orders and associated freight transport equipment information from a freight tracking application;
ii. a software module configured to make electronic progress payments on freight transport contracts.

28. (canceled)

29. The platform of claim 27, wherein the progress payments are made at one or more of: freight pick-up, freight drop-off, a predetermined mileage, a predetermined waypoint, a predetermined distance from the destination, and a predetermined percent completion.

30. The platform of claim 27, wherein the orders and associated freight transport equipment information are communicated to the factoring application periodically, substantially continuously, or in real-time.
